(19) United States
(12) Patent Application Publication
(10) Pub. No.: US 2003/0233722 A1
(43) Pub. Date: Dec. 25, 2003

(54) Wiper blade rubber and process of producing the same

(75) Inventors: Tatsuhiko Sawamura, Tokyo (JP); Yoichiro Tanuma, Tokyo (JP)

Correspondence Address: SUGHRUE MION, PLLC, 2100 PENNSYLVANIA AVENUE, N.W., WASHINGTON, DC, 20037, US

(73) Assignee: GE TOSHIBA SILICONES CO., LTD

(21) Appl. No.: 10/464,636

(22) Filed: Jun. 19, 2003

(30) Foreign Application Priority Data
Jun. 20, 2002 (JP) P. 2002-180588

(51) Int. Cl. B60S 1/38

(52) U.S. Cl. 15/245; 15/250.48

(57) ABSTRACT

A wiper blade rubber is provided, which has low sliding resistance against a glass surface, hardly generates creak and chatter, has good flexibility and bending property at low temperatures, has excellent durability, and has good design property. The wiper blade rubber has a main body, at least an outer surface of which is coated with a silicone rubber, and a wiping layer comprising a high-hardness organic rubber provided by on a tip portion of the main body at a contact side to a glass surface.

### FIELD OF THE INVENTION

The present invention relates to a wiper blade rubber and a process of producing the same. More specifically, the invention relates to a wiper blade rubber having good sliding property against a glass surface and excellent durability and to a process of producing such a wiper blade rubber.

### DESCRIPTION OF THE RELATED ART

Hitherto, natural rubbers or organic rubbers such as CR (chloroprene rubbers) or NBR (butadiene-acrylonitrile rubbers) have been used as wiper blade rubbers for vehicles such as automobiles.

However, wiper blade rubbers comprising such rubbers involved the following problems.

Wiper blade rubbers comprising a natural rubber involved problems such that they are poor in weathering resistance, they deteriorate with the passage of time to possibly cause breakage during acting, and they become hard at low temperatures leading to poor rubber elasticity.

In such wiper blade rubbers comprising a natural rubber, friction resistance (sliding resistance) against a glass surface is decreased by subjecting the surface to chlorination treatment. However, when the chlorination treated layer is worn down, the sliding resistance increases to generate abnormal sounds such as creak or chatter upon contact with the glass surface.

In wiper blade rubbers comprising CR or NBR, similar to the above-described wiper blade rubbers comprising a natural rubber, they are poor in weathering resistance, and their physical characteristics largely rely upon the temperature. In addition, their surface hardness cannot be sufficiently increased. Accordingly, there was a problem that friction resistance (sliding resistance) upon contact with the glass surface is large.

Further, it may be considered to use EPDM (ethylene-propylene-diene terpolymer) having excellent weathering resistance and temperature characteristics as a wiper blade rubber. However, in wiper blade rubbers comprising EPDM, since the surface thereof cannot be subjected to chlorination treatment, it is difficult to reduce sliding resistance against a glass surface. Accordingly, problems such as generation of crack or chatter sounds and reduction in wiping property could not yet be solved.

In addition, any of such wiper blade rubbers comprising an organic rubber are not sufficient in durability (bending durability) and are liable to generate breakage by repetition of bending action. Further, since these wiper blade rubbers use a material that cannot color in light color, they were poor in design property.

Furthermore, it is proposed to constitute wiper blade rubbers of a silicone rubber having excellent weather resistance and bending resistance. However, the silicone rubber is a material that is poor in wear resistance, has large contact resistance against a glass surface, and is hardly subjected to surface treatment. Therefore, such wiper blade rubbers comprising a silicone rubber involved a problem that they cannot solve the generation of creak or chatter sounds. For solving such a problem, it is proposed to add a substance having a lubricating function to the inside of the silicone rubber. However, silicone wiper blade rubbers having such a structure involved a serious problem that the silicone rubber adheres to the glass surface during use to disturb the viewing field. For this reason, it is the present status that automarkers have stood by doing nothing for employing them as genuine parts.

### SUMMARY OF THE INVENTION

The invention has been made to overcome those problems.

Accordingly, one object of the invention is to provide a wiper blade rubber that has low sliding resistance against a glass surface, prevents abnormal sounds such as creak and chatter from generation, has excellent durability, does not have temperature dependency with respect to flexibility, and has good design property.

Another object of the invention is to provide a process of producing the wiper blade rubber.

The wiper blade rubber according to the invention comprises a main body, at least an outer surface of which is coated with a silicone rubber, and a wiping layer comprising a high hardness organic rubber provided by adhesion on a tip portion of the main body at a contact side to a glass surface.

In a preferred embodiment of the wiper blade rubber, the organic rubber comprises EPDM. Further, the thickness of the wiping layer is 2 mm or less. Moreover, the silicone rubber comprises a cured product of an organic peroxide crosslinking type silicone rubber composition.

The process of producing a wiper blade rubber according to the invention is concerned with a process of producing a wiper blade rubber comprising a main body, at least an outer surface of which is coated with a silicone rubber, and a wiping layer comprising a high hardness organic rubber provided by adhesion on a tip portion of the main body at a contact side to a glass surface, the process comprising extrusion molding the main body using an uncrosslinked silicone rubber composition comprising (a) a polyorganosiloxane having at least two aliphatic unsaturated hydrocarbon groups each bonding to a silicon atom, (b) a silica based reinforcing filler, and (c) an organic peroxide crosslinking agent as essential components; simultaneously extrusion molding the wiping layer using an uncrosslinked organic rubber composition comprising the organic rubber and an organic peroxide crosslinking agent as essential components to form a composite molding having a desired shape; and then heating and crosslinking the composite molding.

In the preferred embodiment of the process, the organic rubber comprises EPDM.

The wiper blade rubber according to the invention has a structure in which at least an outer surface of a main body is coated with a silicone rubber, and a wiping layer comprising a high hardness organic rubber is integrally adhered to a tip portion of the main body of wiper blade rubber (at a contact side to a glass surface). Therefore, the wider blade rubber has low sliding resistance against the glass surface and prevents abnormal sounds such as creak and chatter from generation. Further, it has good bending property and excellent durability. Moreover, since it is possible to color the silicone rubber portion in light color, it can reveal excellent design property.

### BRIEF DESCRIPTION OF THE DRAWINGS

FIG. 1 is a sectional view showing a first embodiment of a wiper blade rubber of the invention.

FIG. 2 is a sectional view showing a second embodiment of a wiper blade rubber of the invention.

FIG. 3 is a sectional view showing a third embodiment of a wiper blade rubber of the invention.

### IN THE DRAWINGS

1: wiper blade main body comprising a silicone rubber

2: wiping layer comprising a high hardness organic rubber

3: fitting portion comprising a high hardness organic rubber

4: center portion of the main body, comprising a high hardness organic rubber

5: coating layer comprising a silicone rubber

6: wiper blade main body

7: main body portion comprising a silicone rubber

8: main body portion comprising a high hardness organic rubber

### DETAILED DESCRIPTION OF THE INVENTION

The embodiment of the invention will be described in detail below with reference to the drawings.

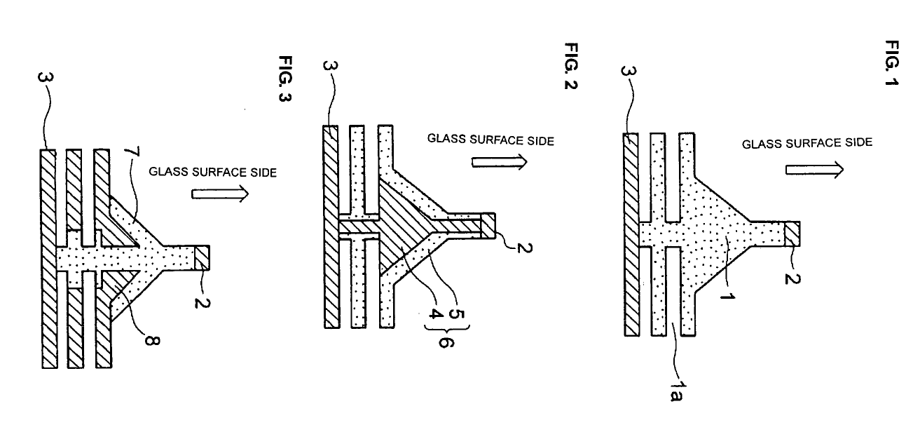

FIG. 1 is a sectional view showing a first embodiment of a wiper blade rubber of the invention. In FIG. 1, 1 shows a wiper blade main body comprising a silicone rubber, and a plurality of convex grooves 1a for fitting a fitment are formed in a lower half portion thereof. A wiping layer 2 comprising a high hardness organic rubber is provided by adhesion on a tip portion of the wiper blade main body 1 at a contact side to a glass surface.

The wiping layer 2 has a thickness of preferably 2 mm or less, and more preferably from 0.01 to 1.0 mm. In general, the thickness is set from the necessity that the tip portion of wiper blade rubber must wipe out raindrops by decreasing contact resistance to a glass surface so that it contact softly with a glass surface. When the thickness of the wiping layer 2 exceeds 2 mm, flexibility becomes poor, thereby likely causing decrease in wiping property and increase in contact resistance. In the case where the thickness of the wiping layer 2 comprising a high hardness organic rubber is sufficiently thin, a sufficiently high surface hardness imparts low contact resistance against the glass surface, and follow-up property to the glass surface is improved by the low hardness silicone rubber layer present inside the wiper blade rubber. Therefore, the wiping property is greatly improved.

In the wiper blade rubber of the first embodiment, since the wiper blade main body 1 that is most required to have bending resistance is constituted of a silicone rubber having excellent weather resistance, whose change in hardness is small against the temperature change, its durability is greatly enhanced. Further, the wiping layer 2 comprising a high hardness organic rubber is formed on a tip potion of the wiper blade main body 1 at a contact side to the glass surface, sliding resistance against the glass surface is reduced, and abnormal sounds such as creak and chatter are not generated during operation. Further, it is possible to overcome an issue of uneven wiping by a constant pressure applied to the tip portion. Moreover, since the silicone rubber can be colored in light color, it is possible to add a design value. In addition, since a fitment-fitting portion 3 is constituted of an organic rubber at a lower end of the wiper blade main body 1, it is easy to fit and fix a wiper fitment.

Second and third embodiments of the invention will be described below.

In the second embodiment, a center portion 4 of a wiper blade main body is constituted of a high-harness organic rubber, and a coating layer 5 comprising a silicone rubber is formed on an outer surface of the center portion 4 of the main body exclusive of a contact portion with a glass surface, as shown in FIG. 2. Further, a wiping layer 2 comprising a high hardness organic rubber is provided on a tip portion of a wiper blade main body 6 having such a structure at a contact side to the glass surface. Moreover, a fitting portion 3 comprising a high hardness organic rubber that may be the same as or different from the organic rubber constituting the wiping layer 2 is also provided at a lower end portion of the wiper blade main body 6.

In the second embodiment, wiping property against the glass surface is further enhanced by excellent impact resilience of the high hardness organic rubber constituting the center portion 4 of the wiper blade main body 6. Further, as compared with the wiper blade rubber of the first embodiment, the amount of the expensive silicone rubber used is reduced. Therefore, a further improvement can be made in the cost.

In the third embodiment, a center portion of a wiper blade main body that is most required to have weather resistance, and design property and an outer surface thereof exclusive of a contact portion with a glass surface are constituted of a silicone rubber, as shown in FIG. 3. Further, a wiping layer 2 comprising a high hardness organic rubber is provided on a tip portion of the wiper blade main body at a contact side to the glass surface. Moreover, a fitting portion 3 comprising a high hardness organic rubber that is the same as or different from the organic rubber constituting the wiping layer 2 is also provided at a lower end portion of the wiper blade main body. In FIG. 3, 7 is a main body portion comprising a silicone rubber, and 8 is a main body portion comprising a high-hardness organic rubber.

In the third embodiment, the amount of the silicone rubber is reduced as compared with the wiper blade rubber of the second embodiment. Therefore, a further improvement can be made in the cost.

In the first to third embodiments, the silicone rubber layer and the organic rubber layer constituting the wiper blade rubber will be further described below.

The silicone rubber layer and the high hardness organic rubber layer are preferably crosslinked and cured with an organic peroxide, and a welded area between those is preferably crosslinked and adhered. For performing crosslinking and crosslinking/adhering with an organic peroxide, for example, a method can be employed in which a silicone rubber composition and an organic rubber composition each containing an organic peroxide based crosslinking agent are molded into a desired shape by two-color extrusion molding as described below, and then heated and crosslinked.

The silicone rubber is a siloxane bond-containing polymer (polyorganosiloxane), and cured products of an organic peroxide curing type thermosetting silicone rubber composition (hereinafter referred to as “peroxide type silicone rubber”) can be used.

Examples of peroxide type silicone rubbers include compositions comprising (a) a polyorganosiloxane having at least two aliphatic unsaturated hydrocarbon groups each bonding to a silicon atom, (b) a silica based reinforcing filler, and (c) an organic peroxide crosslinking agent as essential components.

The component (a) as the chief material may be linear, branched or cyclic in terms of its molecular skeleton, and has a degree of polymerization (the number of Si atoms in the molecule) of from about 10 to 20,000, and preferably from about 100 to 15,000. The silica based reinforcing filler as the component (b) is a filler that is compounded for the purpose of enhancing strength characteristics of the silicon rubber layer formed, and examples thereof include fumed silica, precipitated silica, and fused silica. Especially, those having a particle size of 20 μm or less are suitable. The component (b) may be previously surface treated with an organosilane, an organosiloxane, an organosilazane, etc. Further, reaction products with such a treating agent in-processing may also be used.

The organic oxide as the component (c) is a component functioning as a crosslinking agent of the component (a), and examples thereof include benzoyl peroxide, 2,4-dichlorobenzoyl peroxide, di-tert-butyl peroxide, dicumyl peroxide, 2,5-di-methyl-2,5-di(tert-butylperoxy)hexane, 1,1-di-terbutylperoxy-3,3,5-trimethylcyclohexane, and p-methylbenzoyl peroxide.

This peroxide type silicon rubber is prepared by uniformly kneading the component (b) into the component (a), which is then uniformly mixed with an organic peroxide as the component (c). The compounding amount of the organic peroxide is preferably from 0.1 to 5 parts by weight per 100 parts by weight of the component (a).

For reducing sliding friction resistance against the glass surface, it is preferred to use an organic rubber having a high hardness as far as possible. It is desired to use EPDM, especially high hardness EPDM. In the case where EPDM is used as the organic rubber, it is possible to obtain a wiper blade rubber having excellent wiping performance and excellent adhesion strength to the silicone rubber layer as described above.

EPDM is a polymer obtained by copolymerizing ethylene, propylene and other third component, and those obtained by crosslinking and curing with an organic peroxide are used. Examples of the third component include organic compound monomers having an unsaturated bond in the side chains thereof, such as ethylidene norbomene, 1,4-hexadiene or dicyclopentadiene.

Examples of organic peroxide crosslinking agents for crosslinking EPDM include 1,3-bis(tert-butylperoxyisopropyl)benzene, 2,5-dimethyl-2,5-di(tert-butylperoxy)hexyne-3, dicumyl peroxide, 2,4-dichlorobenzoyl peroxide, benzoyl peroxide, 1,1-diterbutylperoxy-3,3,5-trimethylcyclohexane, 2,5-dimethyl-2,5-dibenzoylperoxyhexane, n-butyl-4,4-diterbutylperoxy valerate, terbutylperoxy benzoate, diterbutylperoxydiisopropylbenzene, terbutylcumyl peroxide, 2,5-dimethyl-2,5-diterbutylperoxyhexane, diterbutyl peroxide, and 2,5-dimethyl-2,5-diterbutylperoxyhexyne-3. Those can be used alone or as mixtures of two or more thereof.

The organic peroxide crosslinking agent is compounded in an amount of preferably from 0.005 to 0.02 moles per 100 g of the organic rubber component in terms of active oxygen amount. In the case where the active oxygen amount is less than 0.005 moles, crosslinking between the rubber molecules may be insufficient. On the other hand, in the case where the active oxygen amount exceeds 0.02 moles, there is possibility that elasticity is lowered so that a rubbery material is not formed. Also, bloom may be generated due to the residual organic peroxide crosslinking agent that was not used for crosslinking.

The method of producing the wiper blade rubber according to the first embodiment of the invention by two-color extrusion molding will be described below.

An uncrosslinked organic rubber composition comprising a mixture of an organic rubber component such as EPDM and the organic peroxide crosslinking agent, and an uncrosslinked silicone rubber composition comprising a mixture of a raw rubber of silicone rubber, an organic peroxide crosslinking agent and a silica based reinforcing filler are each prepared and then charged into each of prescribed input ports of a crosshead type extruder.

By the crosshead type extruder, the silicone rubber composition is extrusion molded into a desired shape of a wiper blade main body, and the organic rubber composition is also extrusion molded on a tip portion and a lower end portion at the fitment-fitting side thereof, to form a wiping portion and a fitting portion.

The thus obtained composite molding is introduced into a crosslinking unit and heated, for example, in the presence of hot air, thereby crosslinking each of the uncrosslinked silicone rubber composition and organic rubber composition, and crosslinking/adhering an interface between these layers. In crosslinking and crosslinking/adhering with such an organic peroxide, a low-pressure hot-air oven (HAV), a fluidized bed heating oven (LCM), a vulcanizer, etc., are preferably used.

Thus, a wiper blade rubber comprising a silicone rubber molded portion and an organic rubber molded portion integrated with each other is obtained. This wiper blade rubber is introduced into a water-cooling unit and water-cooled therein. For removing the peroxide remaining in the product, the product is subjected to post crosslinking at an appropriate temperature for an appropriate period of time (for example, at 150° C. for about one hour), whereby stable characteristics can be obtained.

The invention will be described in detail with reference to the following Example. In the following Example, all parts are a part by weight.

### EXAMPLE

3 parts of dicumyl peroxide as an organic peroxide crosslinking agent was added to and mixed with 100 parts of EP75F (a trade name of JSR Corporation) as EPDM comprising dicyclopentadiene as a third component to prepare an uncrosslinked EPDM composition for molding of a tip wiping portion.

1.5 parts of TC-12 (a trade name of GE Toshiba Silicone Co., Ltd.) as an organic peroxide crosslinking agent was added to and mixed with 100 parts of TSE260-5U (a trade name of GE Toshiba Silicones Co., Ltd.) as a silicone rubber to prepare an uncrosslinked silicone rubber composition for molding a main body.

Those uncrosslinked compositions were extrusion molded using the crosshead type extruder as explained hereinbefore. Thus, there was obtained a wiper blade rubber having a structure in which a wiping layer 2 comprising EPDM was provided by adhesion on a tip portion of a wiper blade main body 1 comprising a silicone rubber, and a fitment-fixing portion 3 comprising EPDM was integrally provided at a lower end thereof, as shown in FIG. 1.

Adhesion strength between the silicone rubber layer and the EPDM layer was measured as physical performance of the thus obtained wiper blade rubber. Further, the function as a wiper was tested.

The adhesion strength between the silicone rubber layer and the EPDM layer was measured in the following manner. A specimen of a composite comprising a laminate of the silicone rubber layer and the EPDM layer was prepared by two-color extrusion molding using a crosshead type extruder. In this specimen, the silicone rubber layer and the EPDM layer were forcibly peeled apart from each other using a tensile tester as defined in JIS K6301. The maximum load during peeling was measured, and the peeling state was also observed.

As a result of this test, it was noted that adhesion between the silicone rubber layer and the EPDM layer was good; and in the case where a load exceeding the adhesion strength was applied, the both layers did not peel apart from each other at the welded area, and the specimen itself revealed breakage (material breakage). Therefore, the adhesion strength between the both layers was sufficiently strong in practical use.

Further, in the function test as a wiper blade rubber, evaluation of wiping performance and test of durability performance were performed using a tester as defined in JIS D5710. Moreover, whether or not the product could be worked smoothly as a wiper blade rubber and whether or not remarkable chatter and abnormal sounds were present were examined.

In the evaluation of wiping performance, the number of lines remaining after wiping water droplets was measured. In the test of durability performance, an initial friction coefficient and a friction coefficient after sliding 100,000 times against ¼-inch glass balls as a counter material were measured using a reciprocating tester under conditions of a sliding speed of 6,000 mm/min, a load of 100 g and a sliding distance (stroke) of 100 mm.

As a result of these tests, in a wiper blade rubber entirely constituted of a silicone rubber, contact friction against the glass surface was large, creak and chatter were observed during the operation, and durability was poor. On the other hand, the wiper blade rubber of the Example was smoothly operated against the glass surface and was good with respect to the wiping performance and durability. Further, regarding whether or not abnormal sounds such as creak and chatter were present during the operation at low temperatures, the wiper blade rubber of the Example showed performance exceeding conventional natural rubber-made wiper blade rubbers.

As is apparent from the above, the wiper blade rubber of the invention has low sliding resistance against a glass surface, prevents abnormal sounds such as creak and chatter from generation, has good flexibility and bending property at low temperatures, and has excellent durability. Further, since it is possible to color the silicone rubber portion in light color, the wiper blade rubber of the invention can exhibit excellent design property.

It should further be apparent to those skilled in the art that various changes in form and detail of the invention as shown and described above may be made. It is intended that such changes be included within the spirit and scope of the claims appended hereto.

This application is based on Japanese Patent Application No. 2002-180588 filed Jun. 20, 2002, the disclosure of which is incorporated herein by reference in its entirety.

What is claimed is:

1. A wiper blade rubber comprising a main body, at least an outer surface of which is coated with a silicone rubber, and a wiping layer comprising a high hardness organic rubber provided by adhesion on a tip portion of the main body at a contact side to a glass surface.

2. The wiper blade rubber as claim 1, wherein the organic rubber is a ethylene-propylene-diene terpolymer.

3. The wiper blade rubber as claimed in claim 1 wherein the wiping layer has a thickness of 2 mm or less.

4. The wiper blade rubber as claimed in claim 1 wherein the silicone rubber comprises a cured product of an organic peroxide crosslinking type silicone rubber composition.

5. A process of producing a wiper blade rubber comprising a main body, at least an outer surface of which is coated with a silicone rubber, and a wiping layer comprising a high hardness organic rubber provided by adhesion on a tip portion of the main body at a contact side to a glass surface, the process comprising extrusion molding the main body using an uncrosslinked silicone rubber composition comprising (a) a polyorganosiloxane having at least two aliphatic unsaturated hydrocarbon groups each bonding to a silicon atom, (b) a silica based reinforcing filler, and (c) an organic peroxide crosslinking agent as essential components; simultaneously extrusion molding the wiping layer using an uncrosslinked organic rubber composition comprising the organic rubber and an organic peroxide crosslinking agent as essential components to form a composite molding having a desired shape; and then heating and crosslinking the composite molding.

6. The wiper blade rubber as claim 5, wherein the organic rubber is a ethylene-propylene-diene terpolymer.

7. The wiper blade rubber as claimed in claim 5 wherein the wiping layer has a thickness of 2 mm or less.

8. The wiper blade rubber as claimed in claim 5 wherein the silicone rubber comprises a cured product of an organic peroxide crosslinking type silicone rubber composition.
